(19) United States
(12) Patent Application Publication
(10) Pub. No.: US 2023/0273324 A1
(43) Pub. Date: Aug. 31, 2023

(54) System to Mitigate hit precision of Cruise Missiles ( CMMS )

(71) Applicants: Alon Wallach, Ramat Gan (IL); Michael Etgar Eisenstadt, Kfar Saba (IL)

(72) Inventors: Alon Wallach, Ramat Gan (IL); Michael Etgar Eisenstadt, Kfar Saba (IL)

(21) Appl. No.: 18/143,149

(22) Filed: May 4, 2023

(51) Int. Cl. G01S 19/01; F41H 11/02

(52) U.S. Cl. CPC G01S 19/015; F41H 11/02

(57) ABSTRACT

A method and system for the rapid and cost effective deployment and operation of a geographically dispersed GNSS RF jammers array, with a deployed geometry of a Cartesian X,Y or Polar R/Theta grids, with a denser “first and/or second line” perimeter, for the purpose of jamming and defeating satellite based GNSS low flying guided munitions, including when equipped with CRPA anti jam antenna, by degrading their coordinates precision. The installed jammers grid creates a dense electronic “minefield” that the invading cruise missile must cross or penetrate within short distance to at least one jammer, close enough to make the first effective jamming and loss of tracking of the invader's GNSS receiver, after which the consecutive and neighboring jammers in the route to the defended target will be close and strong enough for the maintaining of GNSS signal loss, all the way to the target.

This is a new patent application with priority date of May 9, 2022 from Provisional patent application number 63/473,166

### FIELD OF THE INVENTION

The present invention is in the field of GPS and GNSS jamming for the purpose of protection of critical civilian and military assets on the ground from precision hits by GNSS guided munitions, with Cruise Missiles in particular, including those equipped with CRPA jamming nulling capability.

### DESCRIPTION OF RELATED ART

GPS receivers dating back to the 90s were operating in a single civilian frequency of 1575 MHz and receiving the American satellite constellation with a precision of 10 meters or so. In the last decade or so before 2023 this has diversified to GNSS with multitude of bands, frequencies and satellite constellations and precision of 1-3 meters. As depicted in FIG. 1, there are around 5 constellations in 3-4 bands, with a total of about 10 different frequencies.

An attacking cruise missile can be easily equipped with several commercially available GNSS receivers of different bands and frequencies. Jamming GPS in the 90s required a single narrowband jammer at 1575 MHz, while jamming all the new possibilities requires 10 such transmitters.

To make it more problematic, it's usually not a good solution to make a single high-power amplifier and antenna mast that will combine all those frequencies, because of the known problem of “multi carrier saturation”. For example, 10 simultaneous carriers will decrease the actual power available for each carrier not to the anticipated P/10, but to 0.32 of P/10 (0.32=1/square root of 10 carriers). Another way to implement such a jammer would be to make a sweeper that passes all those discrete frequencies, which will not have the multi carrier saturation problem, but it will visit each of those frequencies at a much lower duty factor, in the order of 1/10 or lower, which is again not making good jamming.

To make it even more problematic, jamming a GPS or GNSS receiver has 2 distinct modes: Jamming while receiver is already “tracking”, or maintaining it jammed while its in Acquisition of a valid set of satellites and navigation solution. The jamming amplitude required for jamming a dynamically tracking receiver is usually 2 to 10 times stronger than to only keep it in acquisition.

This means that the main problem to jam an invading cruise missile would be to firstly defeat its GNSS early enough, as the deflection from the planned route caused by reverting to “dead reckoning” navigation in the last stage of the flight is critical for defending a target. We are not talking on shooting down a missile, but rather on “soft jamming” its navigation so precision goes down to around 50-100 meters or worse, preferably 100s of meters off the designated target.

The last big problem in jamming GNSS guided cruise missiles is that some of them (like the Iranian Shahed 136 kamikaze drone) are equipped with CRPA antenna systems. These are usually a 4 antennae array system with support high tech electronics as appearing in FIG. 6A, that generate 3 “nulling lobes” dynamically towards the strongest 3 interferences. A similar 8 antennae system as in FIG. 6B can generate 7 such nulling lobes. These lobes effectively improve the GNSS receiver's immunity by 30-50 dB, which makes jamming almost impractical, unless there are simply a bigger number of strong jammers than nulling lobes at the last critical stage of the flight as in FIG. 6A, 6B.

The combination of all these shortcomings of simple jammers against invading cruise missiles is the driving force behind the present invention.

Numerous related GNSS jamming patents exist, but none of them offers a practical solution to this specific problem of invading cruise missiles or is simply outdated in the sense that it does not deal with multi band GNSS and CRPA of today's environment.

### SUMMARY OF THE INVENTION

Addressing the problems in the Related Art, and considering that such a system of hundreds and thousands of jammer nodes covering towns, cities, regions of a country or even a complete country, must be installed in a very short, time and reasonable budget in case of an immediate threat of a swarm of enemy cruise missiles that can bring down a substantial part of the infrastructure of a country, like in the winter of 2023 in Ukraine where the electric grid and power generation were targeted and almost completely destroyed by Russian guided munitions.

The invention explains 3 slightly different topology implementations of an effective jamming system, and how it should be deployed and dispersed geographically, and how to maximize the jamming effect of each node. It also shows the internal design of a typical single jamming node and 4 ways it can be physically installed and electrically powered, on cars, roofs, over land and water. The invention explains the tradeoffs between the 3 different topologies, and the factors needed to be considered at each type of physical installation.

### BRIEF DESCRIPTION OF THE DRAWINGS

The invention is illustrated in the following 7 figures.

FIG. 1 illustrates the frequency allocations of the known satellite constellations.

FIG. 2 illustrates a jamming grid versus single jammer.

FIG. 3 illustrates the X,Y Cartesian topology deployment

FIG. 4 illustrates the R, Theta Polar topology deployment.

FIG. 5 illustrates the X,Y topology with denser perimeter

FIG. 6A illustrates the 4 antennae CRPA jamming inside a grid.

FIG. 6B illustrates the 8 antennae CRPA jamming inside a grid.

FIG. 7 shows the single jammer node internal buildup and connections.

FIG. 8 illustrates the 4 physical installation ways for each jamming node.

### DETAILED DESCRIPTION OF THE INVENTION

The following description of the drawings will explain how it works.

The description is intended mainly to augment the claims, in combination with the drawings. The drawings are merely illustrative block diagrams with an “artist view” visualization.

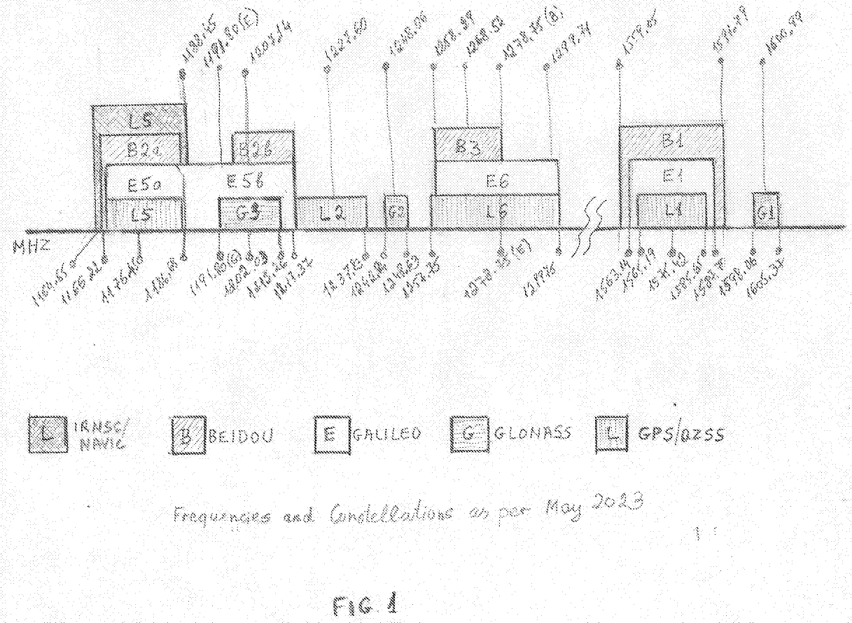

FIG. 1 is the frequency allocations of the various GNSS constellations, for reference purposes only.

FIG. 2 illustrates an incoming cruise missile 3, coming in an attack route 4, targeting infrastructure 2 and reaching 11 jammer nodes 1a to 1k. A 100 Watts jammer 8 is 10 km away and connected with an RF cable 7 to a transmitting antenna 5, sitting on a 10 meters tall pole 6. The X and Y distances of this grid can be 1 km for the sake of easy explanation. In practice the real-world distances are 20-30 km for the big 100 W jammer, and 2-3 km for the distance between adjacent grid points (same relative distances as our numeric example). Looking at the distance of cruise missile 3 at its drawn position, one can see that the first jammer nodes of 1a, 1d, 1g and 1i are the first to affect the missile's GNSS reception, with id being the closest, about 0.3 km away in the closest point to route 4. The next one being very close to route 4 is 1h, even 0.2 km.

Now, remembering that radio propagation is isotropic and decreases with the square of the distance, the 1h jammer will be 50 times closer to the cruise missile than a 100W jammer 8, and will have a 2500 power advantage over jammer 8. Let's say that jammer 1h has only 1 W of power, it will still jam 2500/100 times stronger, or 25 times better than jammer 8.

This is the basic advantage of using a grid over conventional high power “regional” jammers like the 100 W jammer 8. The distances from the grid jammers to the cruise missile during its flight into the grid are way smaller, and statistically the cruise missile will have to pass super close to one or more of the on-route jammer nodes, with very high jamming signal level at that point.

This super proximity will ensure the sought objective of knocking out the cruise missile's GNSS from tracking mode into acquisition, After such a knockout, the remaining nodes on-route will keep the CiNSS receiver “blind” and trying to regain tracking without success.

One can also assume that transmitting 1 W directly from 1d transmitter, without a 10 m cable, gives an RF advantage of several dB because of saving the RF loss of cable 7 in 1500 Mhz. All the above point to the basic advantage of the grid system over conventional regional jamming techniques.

Continuing to FIG. 3 with a cruise missile 3A trying to enter and precisely hit infrastructure 2, passing several close jamming nodes of the X,Y grid in route 4A, or cruise missile 3B coming to same target 2 from a different direction 4B. Again, the superiority of the grid over conventional regional jamming is self-explanatory.

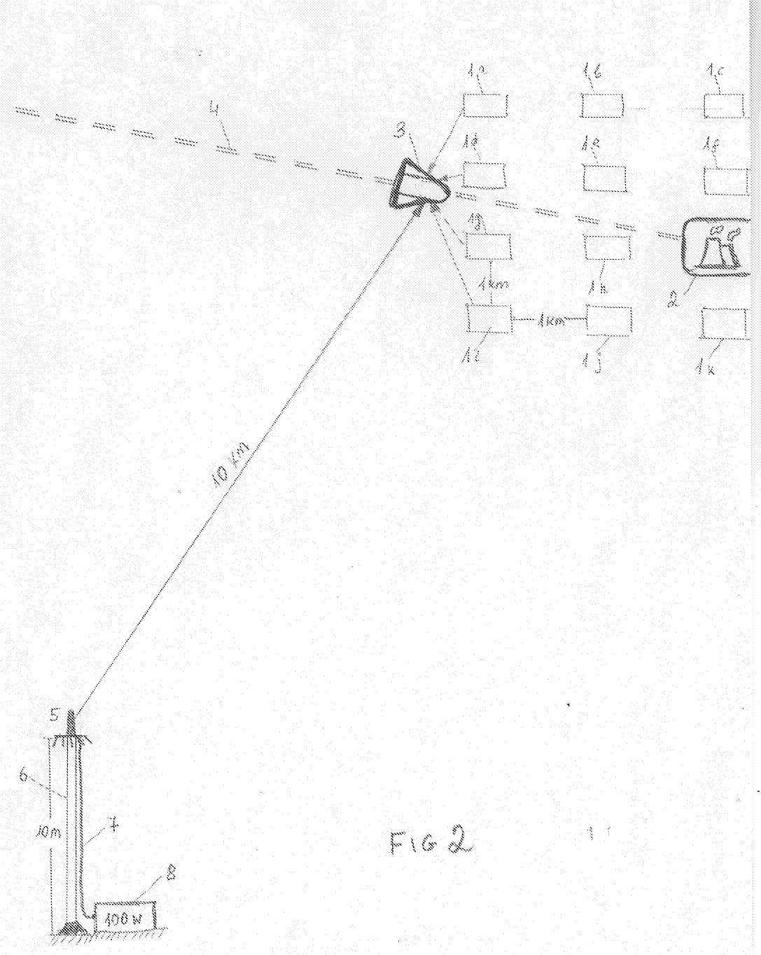

FIG. 4 illustrates the same concept and advantage but in a Polar coordinate topology or R and Theta. The Polar dispersion of grid points has some advantage for defending a city, where the more important assets are concentrated in the city center, in contrast to a uniform distribution of assets around the country, usually in the countryside.

FIG. 5 illustrates the preferred embodiment of an X,Y grid deployment, but with denser dispersion of grid points in its perimeter. Jammer nodes 1A are making the standard distance between jammer nodes 1 into half the distance. Cruise missile 3A therefore has no choice but to pass even closer to a jamming node when it enters the grid in route 4A. This close passing will knock out the GNSS receiver of the cruise missile 3A, after which the general normal distance grid will maintain it in Acquisition all the way to target 2.

This combined grid with denser perimeter will naturally require more grid points than a standard X,Y grid, but it has a more predictable performance, and overall has better efficiency.

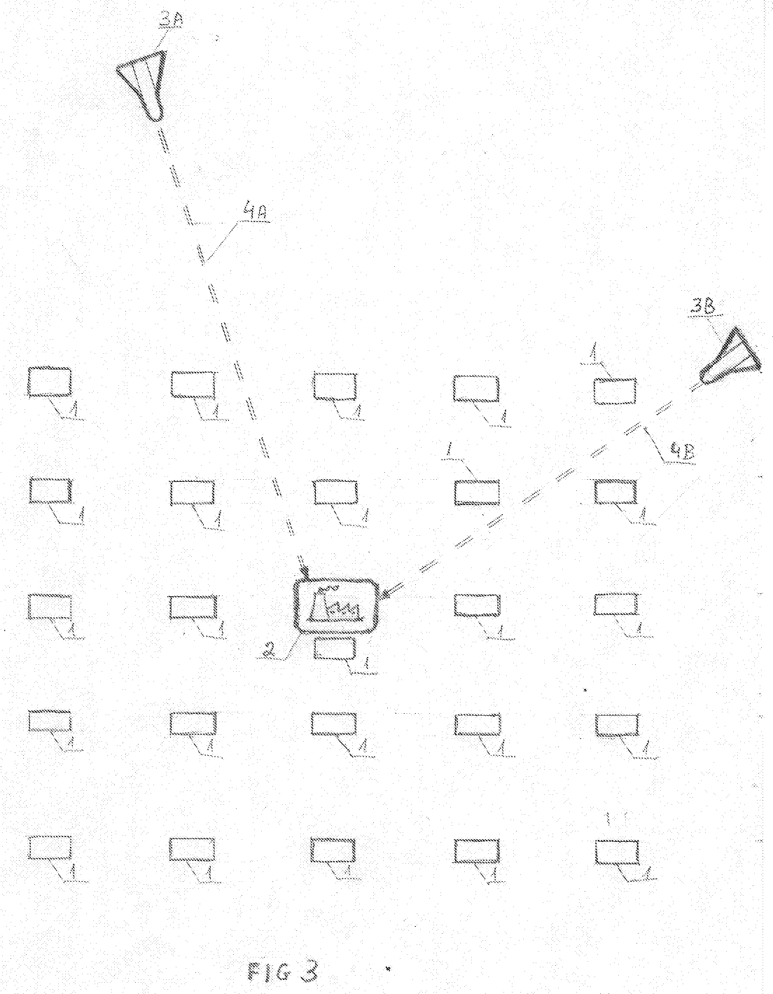

FIG. 6A shows a cruise missile 3a that has a 4 elements CRPA antenna array. As it enters the grid in point 5A. When it continues on route to target 2, it encounters 5 jammers at point 6A. Same can be seen for cruise missile 3B reaching point 5B, 6B and 7B. The deeper it advances into the grid, the more signals are jamming it. Eventually it will be knocked out to Acquisition even with its CRPA.

FIG. 6B shows the performance for an 8 element CRPA equipped cruise missile 3A. Such an 8 elements antenna can take care of up to 7 jamming sources, so 8 sources are required to jam it, which will make the distances of the farther jammers 1a and 1d too far to effectively jam. The solution for grid jamming an 8 elements CRPA is therefore to reduce the dX and dY spacings of the grid to ½ of their nominal distances for 4 elements CRPA. This last illustration and discussion are important and proves that the grid can deal and defeat ANY size of CRPA elements array, with the proper dX and dY spacing.

FIG. 7 illustrates what each jammer node includes: The jammer itself is 13, shown with an array of antennas mounted directly on its RF outputs. Each antenna is matched to the frequency it transmits, so 1-5 antennas are shown with slightly different lengths, all the way to Antenna n. In principle each jammer will include all the possible frequencies which are potential for the specific threat of that arena. For example, if intelligence exists that the cruise missiles are relying on CRPA at L1 1575 MHz and another band like L2 at 1176 MHz without CRPA, then this jammer will probably have 2-3 transmissions at 1575, and 1-2 only at 1176. This will maximize the chances of complete jamming.

The jammer is built inside from modular blocks of transmission, each with different frequency, but they are essentially interchangeable between them, and directly driving their respective antenna.

The jammer is mounted inside a rain proof outdoor installation box 11, which is made from non-conductive materials like ABS or Epoxy. This enables to have the RF jammer itself be non rain proof, but still comply with outdoor installation.

This configuration is ideal in the sense of manufacturing price, size, ease of installation, and overall transmitted power versus DC input power, which is limited in many cases, especially in mobile installations.

A UHFRX 12 is inside the same non conductive enclosure, with its UHF antenna 15 connected with a 1 m or so cable to the receiver inside. UHFRX 12 is a remote-control receiver that listens and waits for an ON/OFF command from UHFTX 16, which can be tens of kilometers away.

UHF RX 12 can be associated (paired to) with several UHF TX 16 units, depending on how neighboring grids are divided between regions, headquarters etc. One or several grids can be turned on simultaneously with one button, or from several places. Mode operation selector 14 enables manual on/off switching of the jammer when standing by it or setting it to “remote” mode where UHF TX 16 will decide remotely if turned on.

DC Power is supplied from power cable 17, and power merging and display unit 18 will enable feed from 12V DC or 120/220V AC mains power. The display in Power merging unit 18 will show the current and total power consumed by the jammer node. This is the cheapest and most intuitive indication of correct operation of jammer. The displayed power in Watts is very stable and doesn't change even when DC voltage changes, because jammer unit has high efficiency DC/DC converter inside and efficiency is maximal.

FIG. 8 shows 4 installation types:

Car installation with rain proof enclosure 11A mounted on car roof. 15A UHF antenna mounted on car roof, and power meter 18A is in the car's cabin. The 12V power can be drawn from cigarette lighter jack of car, or directly from car's battery through alligator clips etc.

Sea or River installation over a buoy: Same as car installation except the buoy has a solar panel 21B, rechargeable battery 22B, and power meter 18B.

Tripod installation: Same as car installation, except car is replaced by a tripod stationed on the ground, and solar panel 21C and rechargeable battery 22C.

Building roof installation: same as car installation except it can have all energy, options: 12v, 220V and solar panel. Rain proof enclosure 11D and UHF antenna 15A are mounted on roof, with long DC cable 17D going down to power merging and meter 18D.

What is claimed is:

1) An array of GNSS signal RF jammers evenly dispersed, installed or mounted over ground, on cars, on buildings, water, sea etc., over a region of 10-100 and more kilometers in X and Y directions, in a grid format, and turned on simultaneously by a common remote control, in case of a precise GNSS based attack of guided munitions, cruise missiles, suicide drones etc. The spacing between adjacent jammers in X and Y is 0.5-2 times the confirmed measured jamming radius of each jammer, where said jamming range is defined as the distance which the jammer can cause a GNSS receiver similar to the one employed in the threat attack platform, to lose its tracking mode into acquisition mode. Said grid is protecting critical infrastructures in said region by causing said threat guided munition or cruise missile to fly its last lag in “dead reckoning” without precise dynamic GNSS position update, and thereby miss its designated target by 50 meters or more, mitigating the damage to said target.

2. The grid of claim 1 where the dispersion of jammers is in a different grid, like an R Theta dispersion, where the radial distance between adjacent jammers is 0.5-2 times of said jamming radius of a single jammer, and the tangential distance between adjacent jammers is either in degrees or in kilometers.

3. The grid of claim 1 where the dispersion is in any geometry or topology, including arbitrary location of jammers, while the average distance between adjacent jammers is 0.5-2 times of said jamming radius.

4. The grid of claim 1 where the outer perimeter line or first 2 outer lines of said grid is denser with jammers, by a factor of 1.3 to 3 times from remaining grid, for increasing the chances of jamming a tracking GNSS receiver into Acquisition mode immediately at the entry into said protected grid area.

5. The jammer of claim 1 comprising multitude of output channels, each covering a different frequency slot out of the 10 or more assigned frequencies of the various bands and satellites constellation of GNSS. Said jammer feeds directly without any feed cable, a number of quarter wave matched antennas.

6. The jammer of claim 5 where said jammer is housed in a non conductive rain proof enclosure.

7. The jammer of claim 5 further switched on remotely by a UHF receiver, by cellular module, or any other means of remote control, to enable simultaneous switching on of particular sectors of said grid, or all of it.

8. The jammer of claim 1 further powered by 12 Volts DC power from car cigarette lighter plug, or directly from said car 12v main battery, or any 12v battery, independent or coupled to a charging solar energy panel. Said jammer can also be powered by 120 or 230V AC mains power through a DC power supply.

9. The jammer of claim 1 where a DC power panel meter is connected in series between supply voltage and said jammer, to display the consumed power by said jammer while switched on.

10. The jammer of claim 1 installed in an enclosure, with said enclosure further comprises of a remote/manual selector and optional display lamps. Said selector enables manual switching on when such mode is required or when UHF remote control is not working for any reason.
